(19) United States
(12) Patent Application Publication
(10) Pub. No.: US 2026/0313641 A1
(43) Pub. Date: Oct. 8, 2026

(54) MODULATION AND CODING SCHEME FOR MULTIPLE TRANSPORT BLOCK TRANSMISSION AND LOGICAL CHANNEL QUALITY OF SERVICE

(71) Applicant: Lenovo (United States) Inc., Morrisville, NC (US)

(72) Inventors: Joachim Löhr, Wiesbaden (DE); Alexander Golitschek Edler von Elbwart, Darmstadt (DE)

(73) Assignee: Lenovo (United States) Inc., Morrisville, NC (US)

(21) Appl. No.: 19/170,739

(22) Filed: Apr. 4, 2025

(51) Int. Cl. H04W 72/1268; H04W 72/56

(52) U.S. Cl. CPC H04W 72/1268; H04W 72/56

(57) ABSTRACT

Various aspects of the present disclosure relate to modulation and coding scheme (MCS) for multiple transport block (TB) transmission and logical channel (LCH) quality of service (QoS). A user equipment (UE) may receive multiple uplink resource assignments for overlapping scheduled uplink transmissions. The UE may perform logical channel prioritization (LCP) procedures, where an LCP procedure of the LCP procedures is performed for each of the multiple uplink resource assignments.

### TECHNICAL FIELD

The present disclosure relates to wireless communications, and more specifically to modulation and coding scheme (MCS) for data transmission.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive multiple uplink resource assignments for overlapping scheduled uplink transmissions; and perform logical channel prioritization (LCP) procedures, where an LCP procedure of the LCP procedures is performed for each of the multiple uplink resource assignments.

A processor (e.g., a standalone processor chipset, or a component of a UE) for wireless communication is described. The processor may be configured to, capable of, or operable to perform one or more operations as described herein. For example, the processor may be configured to, capable of, or operable to receive multiple uplink resource assignments for overlapping scheduled uplink transmissions; and perform LCP procedures, where an LCP procedure of the LCP procedures is performed for each of the multiple uplink resource assignments.

A method performed or performable by a UE for wireless communication is described. The method may include receiving multiple uplink resource assignments for overlapping scheduled uplink transmissions; and performing LCP procedures, where an LCP procedure of the LCP procedures is performed for each of the multiple uplink resource assignments.

In some implementations of the UE, the processor, and the method described herein, the UE, the processor, and the method may be configured to, capable of, or operable to perform the LCP procedures in a predefined order. In some implementations of the UE, the processor, and the method described herein, the UE, the processor, and the method may be configured to, capable of, or operable to receive downlink control information (DCI) that includes the multiple uplink resource assignments, and where the DCI includes indications of at least one MCS for each of the scheduled uplink transmissions.

In some implementations of the UE, the processor, and the method described herein, the LCP procedure is a single LCP procedure performed for the multiple uplink resource assignments that schedule the overlapping scheduled uplink transmissions. In some implementations of the UE, the processor, and the method described herein, the overlapping scheduled uplink transmissions are at least partially overlapping in time domain.

In some implementations of the UE, the processor, and the method described herein, the UE, the processor, and the method may be configured to, capable of, or operable to perform the LCP procedures in an order of a MCS that is associated with an uplink resource assignment of the multiple uplink resource assignments. In some implementations of the UE, the processor, and the method described herein, a first LCP of the LCP procedures is performed for the uplink resource assignment associated with a lowest MCS of multiple MCSs associated with the multiple uplink resource assignments.

An NE (e.g., a base station) for wireless communication is described. The NE may be configured to, capable of, or operable to perform one or more operations as described herein. For example, the NE may be configured to, capable of, or operable to transmit DCI that includes multiple uplink resource assignments for overlapping scheduled uplink transmissions, where the DCI includes indications of at least one MCS for each of the scheduled uplink transmissions.

A processor (e.g., a standalone processor chipset, or a component of a NE) for wireless communication is described. The processor may be configured to, capable of, or operable to perform one or more operations as described herein. For example, the processor may be configured to, capable of, or operable to transmit DCI that includes multiple uplink resource assignments for overlapping scheduled uplink transmissions, where the DCI includes indications of at least one MCS for each of the scheduled uplink transmissions.

A method performed or performable by an NE (e.g., a base station) for wireless communication is described. The method may include transmitting DCI that includes multiple uplink resource assignments for overlapping scheduled uplink transmissions, where the DCI includes indications of at least one MCS for each of the scheduled uplink transmissions.

In some implementations of the NE, the processor, and the method described herein, the overlapping scheduled uplink transmissions are at least partially overlapping in time domain. In some implementations of the NE, the processor, and the method described herein, a LCP procedure is associated with each of the multiple uplink resource assignments.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of channel fluctuation, in accordance with aspects of the present disclosure.

FIG. 4 illustrates an example of a virtual transport block (TB) representative of multiple TBs over a frequency allocation, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a TB refers to a block of data (e.g., a data payload) communicated (e.g., transmitted, sent, output, received, signaled) between a physical layer and one or more higher layers (e.g., medium access control (MAC) layer). At a transmitter side, the MAC layer organizes data to be communicated into TBs, and the physical layer processes (e.g., encodes, modulates) the TBs for communication. At a receiver side, the physical layer processes (e.g., decodes, demodulates) the communication (e.g., reception, received) signal to extract the TBs, and provides the TBs to the MAC layer. The TB can be divided into multiple smaller blocks referred to as data blocks, CBs, or CBGs, allowing larger amounts of data to be encoded, transmitted, and decoded efficiently. Different data blocks, CBs, and/or CBGs can be grouped into or associated with different logical channels (LCHs), where each LCH can carry different types of data (e.g., control data, user data, signaling data, and so forth). Each LCH can be associated with a different priority, such as higher priority LCHs having higher quality of service (QoS) requirements or settings than lower priority LCHs.

A data block is communicated (e.g., transmitted, sent, signaled) on one or more resource blocks (RBs). An RB refers to a unit of time and frequency resources. For example, for 5G NR, an RB may include twelve (12) subcarriers in the frequency domain and a number of orthogonal frequency division multiplexing (OFDM) symbols in the time domain (e.g., depending on the subcarrier spacing).

Some wireless communications systems, such as 6G systems, may support a bandwidth in a wider range than previous wireless communications systems, such as a bandwidth in the range of approximately 100 megahertz (MHz) or more. In such situations, the radio channel (e.g., depending on the environment and/or deployment) may encounter not only small-scale fluctuations within a few decibels (dB), but may also encounter larger fluctuations. This may be compensated for in link adaptation by selecting an MCS that is adapted to the average link quality over the assigned bandwidth. The resource signaling for 5G NR supports only a single MCS signaling per TB for a downlink resource assignment or an uplink resource grant.

Given the single MCS signaling per TB, current (5G NR) link adaptation cannot exploit frequency ranges with better signal-to-interference-plus-noise ratio (SINR) by a reduced forward error correction (FEC) overhead, nor can it assign a more robust FEC to data mapped on frequency ranges with a poor MCS. This becomes particularly relevant for a case of very narrow beams, where there is no or extremely limited flexibility to assign frequency ranges according to the best channel out of a group of UEs (such as RB range 1 to UE1 with good SINR, RB range 2 to UE2 with good SINR). Currently, only a single TB transmission using one MCS is supported in the UE. Accordingly, the current techniques do not support multiple concurrent TBs or physical uplink shared channels (PUSCHs) in a slot (5G NR). Another drawback of the current link adaptation and resource signaling scheme (up to 5G NR) is that the transport block generation and transmission procedure is inefficient, with only a single common MCS applied to all of the data multiplexed in a TB, even though the data of different LCHs may have different QoS requirements. Typically, the MCS for a TB is selected by the network for the highest demanding QoS of the data in a TB and an average link quality over the assigned bandwidth.

Aspects of the present disclosure are described in the context of a wireless communications system. As described herein, the techniques support the concurrent transmission of multiple TBs or PUSCH transmission in uplink communication. Several aspects of an LCP procedure are described for scenarios where a UE has multiple (at least partially) overlapping uplink (UL) grants. In order to ensure that data with high QoS requirements is allocated to an UL grant with an appropriate MCS, some order is defined in which the multiple LCPs are executed. Furthermore, power control aspects for scenarios where a UE has multiple, concurrent UL grants are described.

Aspects of this disclosure are related to a UE that performs multiple LCP procedures according to a predetermined order when the UE is allocated multiple UL grants concurrently (multiple TB allocation) for one serving cell. The LCP order can be defined according to several options (e.g., the LCPs are executed in an order of MCS level, starting with the lowest MCS).

Aspects of this disclosure are related to a UE that performs a single common LCP procedure across multiple UL grants or PUSCH allocations allocating UL resources for an initial transmission. The UE accumulates the individual UL resources assigned by the individual UL grants or allocations and performs one common LCP procedure on the sum of the UL resources. In an example, a UE determines the corresponding TB sizes for each of the multiple UL grants and calculates an accumulated TB size (e.g., as a sum of the individual TB sizes).

Aspects of this disclosure are related to a UE applies a relative priority order for multiple, concurrent PUSCH transmissions in one serving cell when the UE is power limited and needs to apply power scaling to the UL transmissions. In an example, the PUSCH transmission with the lowest MCS has the highest relative priority among the multiple, concurrent PUSCH transmissions.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

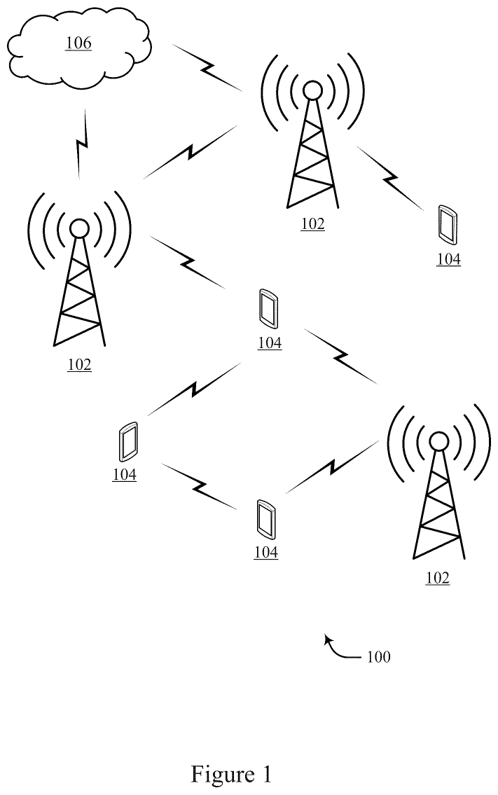

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support the concurrent transmission of multiple TBs or PUSCH transmission in uplink communication. Several aspects of an LCP procedure are described for scenarios where a UE has multiple (at least partially) overlapping UL grants. In order to ensure that data with high QoS requirements is allocated to an UL grant with an appropriate MCS, some order is defined in which the multiple LCPs are executed. Furthermore, power control aspects for scenarios where a UE has multiple, concurrent UL grants are described. For example, an NE 102 and a UE 104 in the wireless communications system 100 may support aspects of the described techniques for MCS for multiple TB transmission and LCH QoS.

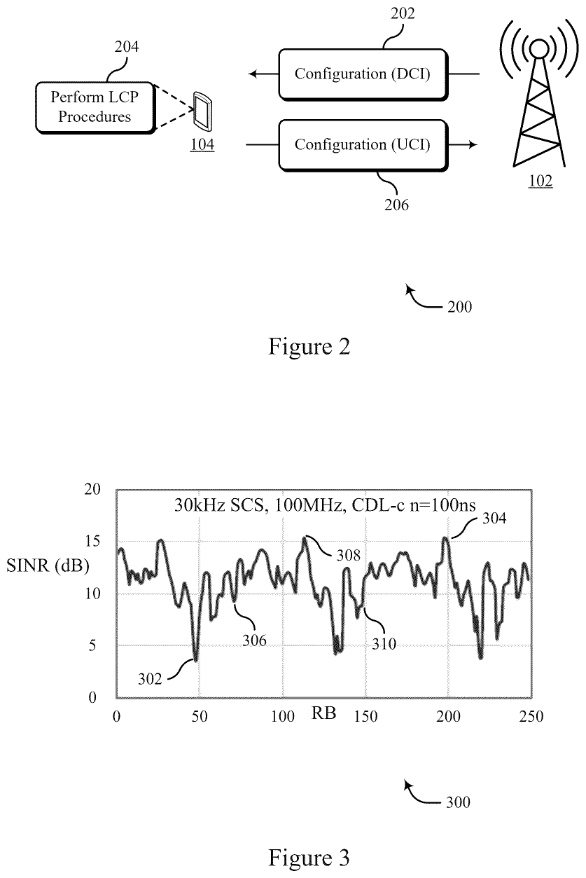

FIG. 2 illustrates an example 200 of wireless communication in accordance with aspects of the present disclosure. In the example 200, an NE 102 communicates (e.g., transmits, sends, signals) a configuration 202 (e.g., a configuration message) to a UE 104. The configuration 202 (e.g., DCI) includes multiple uplink resource assignments for overlapping scheduled uplink transmissions. The UE 104 receives the multiple uplink resource assignments for overlapping scheduled uplink transmission. The UE 104 performs LCP procedures (at 204), where an LCP procedure of the LCP procedures is performed for each of the multiple uplink resource assignments. The UE 104 communicates (e.g., transmits, sends, signals), to the NE 102, configuration uplink control information (UCI) 206 that indicates a configuration of the UE 104. The NE 102 receives the configuration UCI that indicates the configuration of the UE 104.

FIG. 3 illustrates an example 300 of channel fluctuation in accordance with aspects of the present disclosure. The example 300 illustrates SINR in a transmit (Tx) wireless communication channel having 30 kilohertz (kHz) subcarrier spacing (SCS) across a 100 MHz bandwidth, using a clustered delay line (CDL) profile CDL-C, where n=100 nanoseconds. As illustrated, the Tx channel has channel fluctuation of greater than 10 dB, such as from approximately 4 dB at 302 to over 15 dB at 304. Using the techniques discussed herein, the UE 104 can select MCS for multiple TB transmission and LCH QoS, such as an MCS for RB 75 through RB 120 because the channel fluctuation between RB 75 and RB 120 is approximately 6 dB (e.g., 9 dB at 306 and 15 dB at 308) and a different MCS for RB 120 through RB 150 because the channel fluctuation between RB 120 and RB 150 is approximately 11 dB (e.g., 15 dB at 308 and 4 db at 310).

With reference to frequency resource assignment (downlink (DL)/UL), according to 3rd Generation Partnership Project (3GPP) technical specification (TS) 38.212, both UL and DL resource assignments support only 1 single MCS assignment applicable to all assigned resource blocks. DCI Format 0_0 refers to a modulation and coding scheme of 5 bits. DCI Format 0_1 refers to, for TB 1, a modulation and coding scheme of 5 bits as defined in Clause 6.1.4.1 of 3GPP TS 38.214, and for TB 2 (only present if maxRank or maxMIMO-Layers is larger than 4), a modulation and coding scheme of 5 bits as defined in Clause 6.1.4.1 of 3GPP TS 38.214.

DCI Format 0_2 refers to a modulation and coding scheme of 5 bits as defined in Clause 6.1.4.1 of 3GPP TS 38.214. DCI Format 0_3 is used for the scheduling of one PUSCH in one cell, or multiple PUSCHs in multiple cells with one PUSCH per cell. The modulation and coding scheme is a number of bits determined by the following: block number 1, block number 2, . . . , block number

$${N}_{cell}^{UL} .$$

Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214.

DCI Format 1_0 refers to a modulation and coding scheme of 5 bits. DCI Format 1_1, for TB 1, refers to a modulation and coding scheme of 5 bits as defined in Clause 5.1.3.1 of 3GPP TS 38.214, and for TB 2 (only present if maxNrofCodeWordsScheduledByDCI equals 2), refers to a modulation and coding scheme of 5 bits as defined in Clause 5.1.3.1 of 3GPP TS 38.214. DCI Format 1_2 refers to a modulation and coding scheme of 5 bits as defined in Clause 5.1.3.1 of 3GPP TS 38.214.

DCI Format 1_3 is used for the scheduling of one physical downlink shared channel (PDSCH) in one cell, or multiple PDSCHs in multiple cells with one PDSCH per cell. For TB 1: the modulation and coding scheme is a number of bits determined by the following: block number 1, block number 2, . . . , block number

$${N}_{cell}^{DL} .$$

Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214. For TB 2: the modulation and coding scheme is a number of bits determined by the following: block number 1, block number 2, . . . , block number

$${N}_{cell}^{DL , 3} .$$

DCI Format 4_0 refers to a modulation and coding scheme of 5 bits as defined in Clause 5.1.3 of 3GPP TS38.214. DCI Format 4_1 refers to a modulation and coding scheme of 5 bits as defined in Clause 5.1.3 of 3GPP TS38.214. DCI Format 4_2 refers to, for TB 1, a modulation and coding scheme of 5 bits as defined in Clause 5.1.3.1 of 3GPP TS 38.214, and for TB 2 (only present if maxNrofCodeWordsScheduledByDCI equals 2), a modulation and coding scheme of 5 bits as defined in Clause 5.1.3.1 of 3GPP TS 38.214.

While DCI formats 0_3/1_3 are capable of signaling a plurality of MCS fields, each such MCS field is applicable to a whole cell, and therefore to a single TB (i.e., the same MCS is applied to a TB).

Aspects of the present disclosure include techniques that support the concurrent transmission of multiple TBs or PUSCH transmission in uplink communication. Several aspects of an LCP procedure are described for scenarios where a UE has multiple (at least partially) overlapping UL grants. In order to ensure that data with high QoS requirements is allocated to an UL grant with an appropriate MCS, some order is defined in which the multiple LCPs are executed. Furthermore, power control aspects for scenarios where a UE has multiple, concurrent UL grants are described.

In some techniques, the logical channel prioritization and TB generation procedure would be performed regardless of the QoS requirements of a LCH (e.g., only the logical channel priority and the configured physical resource block (PRB) for LCHs determines the number of resources and/or bits allocated to a LCH during LCP. A single TB with a common MCS is used regardless of the different types of data multiplexed in the TB. Therefore, the corresponding PUSCH transmission would be inefficient from a resource usage and spectral efficiency perspective. The techniques described herein provide for an increased spectral efficiency by considering the QoS requirements of data multiplexed in a TB and selection of an appropriate MCS. Multiple concurrent TBs and PUSCHs are supported to benefit from an optimized, efficient link adaptation by exploiting frequency ranges with better SINR by a reduced FEC overhead, or by assigning a more robust FEC to data mapped on frequency ranges with a poor SINR.

In one or more implementations, a UE performs multiple LCP procedures according to a predetermined order when the UE is allocated multiple UL grants concurrently (multiple TB allocation) for one serving cell. The LCP order can be defined according to several options (e.g., the LCPs are executed in an order of MCS level, starting with the lowest MCS). For example, a first LCP is applied for an UL grant or allocation with the lowest MCS, a second LCP is applied for an UL grant or allocation with the second lowest MCS, etc.

In one or more implementations, a UE performs a single common LCP procedure across multiple UL grants or PUSCH allocations allocating UL resources for an initial transmission. The UE accumulates the individual UL resources assigned by the individual UL grants or allocations and performs one common LCP procedure on the sum of the UL resources. In an example, a UE determines the corresponding TB sizes for each of the multiple UL grants and calculates an accumulated TB size (e.g., as a sum of the individual TB sizes).

In one or more implementations, a UE applies a relative priority order for multiple, concurrent PUSCH transmissions in one serving cell when the UE is power limited and needs to apply power scaling to the UL transmissions. In an example, the PUSCH transmission with the lowest MCS has the highest relative priority among the multiple, concurrent PUSCH transmissions.

With reference to multiple TBs in a slot, or transmission time interval (TTI), a DCI allocates multiple TBs or hybrid automatic repeat request (HARQ) processes within a slot. In an implementation, a highest priority data is mapped to the most demanding LCHs, where a first LCP is applied for the lowest MCS, and a second LCP is applied to a second lowest MCS. In an alternative implementation, a UE applies LCP in the order of allocations (i.e., a first signaled allocation and MCS is used for a first LCP, a second signaled allocation and MCS within DCI is used for the second LCP, etc.). With reference to the LCP order, power control is considered for power headroom (PHR) and power scaling or prioritization. In an implementation, a DCI allocates UL resources (as in legacy) and a UE determines whether to generate multiple TBs within the allocated UL resources. A UCI indicates TB information (similar to UL DCI information), and HARQ aspects are considered, such as which HARQ processes to use for the multiple TBs.

In one or more implementations, a UE performs multiple LCP procedures according to a predetermined order when being allocated multiple UL grants concurrently (multiple TB allocation) for one serving cell. According to an implementation, the order is defined according to one or more alternative options. As a first option, the LCPs are executed in the order of MCS level, starting with lowest MCS. A first LCP is applied for UL grant or allocation with lowest MCS, and a second LCP is applied for an UL grant or allocation with the second lowest MCS. As an alternative second option, a UE executes the LCPs in the order of UL allocations (i.e., a first signaled UL allocation or MCS is used for the first LCP, a second signaled allocation or MCS within DCI is used for the second LCP etc.). This alternative assumes that the UE receives one DCI which is allocating multiple UL resources (each with a MCS as in the current specifications), and the UE performs the LCP(s) according to the order signaled within the DCI. As an alternative third option, it can be left to the UE implementation, where the UE maximizes the transmission of data and at the same time multiplexes the data according to the QoS requirements for the corresponding UL grants.

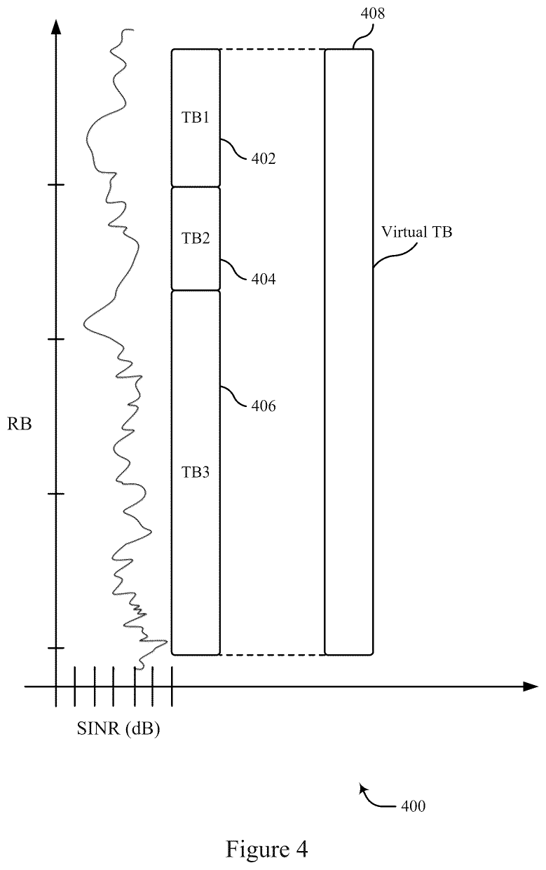

FIG. 4 illustrates an example 400 of a virtual transport block (TB) representative of multiple TBs over a frequency allocation, in accordance with aspects of the present disclosure. In this example 400, three UL resource allocations (i.e., TB1 402, TB2 404, and TB3 406) span over a large frequency allocation. The UL grants of the resource allocations are summed and represented as a virtual TB 408 over the RB resources. In one or more implementations, a UE performs a single common LCP procedure across multiple UL grants or PUSCH allocations, allocating UL resources for an initial transmission. According to an implementation, the UE accumulates the individual UL resources assigned by the individual UL grants or allocations and performs one common LCP procedure on the sum of the UL resources. In an example, the UE determines the corresponding TB sizes for each of the UL grants and calculates an accumulated TB size (e.g., a sum of the individual TB sizes). Subsequently, the UE performs an LCP procedure on the accumulated TB size, and the resulting “virtual” common TB 408 is then mapped to the individual UL grants and/or TBs.

In one or more implementations, uplink power control is applied to each PUSCH and/or TB allocation for scenarios where a DCI allocates multiple PUSCH resources each for a single TB. For cases where a UE is allocated with multiple (at least partially overlapping) UL grants concurrently, the UE applies a separate UL power control for each PUSCH allocation or transmission occasion. In an example, the legacy power control formula is applied for each PUSCH allocation:

$${P}_{PUSCH , b , f , c , k} ( i , j , {q}_{d} , l ) = min \{ \begin{matrix}{P}_{CMAX , f , c , k} ( i ) \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

In an implementation, the same PUSCH power control adjustment state f_{b,f,c}(i, l) is applied to the multiple, concurrent PUSCH transmissions. In an example, the same parameter set configuration j is used for the multiple, concurrent PUSCH transmissions.

In one or more implementations, a single power control is applied for multiple (at least partially overlapping) PUSCH allocations or TBs for one serving cell. In an example, a UE accumulates the RBs assigned for each individual UL grant or allocation to compute the uplink transmission power. One of the factors or elements the power control formula is constructed of (i.e., Δ_{TF,b,f,c}(i)) and is calculated based on the MCS used for the PUSCH transmission (e.g., power is adjusted according to the used MCS). Given current specifications and only one MCS is used for a single TB or PUSCH transmission, the implementation suggests a UE behavior for the scenario where multiple PUSCHs with different MCSs are allocated for a serving cell (e.g., the UE has multiple overlapping UL grants in one serving cell).

In an example, one or more of several options may be selected for a determination of the PUSCH transmit power. As an implementation first option, a lowest MCS of the set of MCSs used for a PUSCH is used for the determination of Δ_{TF,b,f,c}(i). As an implementation second option, a highest MCS of the set of MCSs used for a PUSCH is used for the determination of Δ_{TF,b,f,c}(i). As an implementation third option, an average MCS (e.g., determined based on a set of MCSs used for a PUSCH, is used for the determination of Δ_{TF,b,f,c}(i). As an implementation fourth option, a lowest MCS plus some delta MCS is used for the determination of Δ_{TF,b,f,c}(i). According to an implementation, the same power density (e.g., power per RB, is used for the multiple, concurrent PUSCH transmissions.

In one or more implementations, a UE applies a relative priority order for multiple, concurrent PUSCH transmissions in one serving cell when the UE is power limited and needs to apply power scaling to the UL transmissions. According to an implementation, the PUSCH transmission with the lowest MCS has the highest relative priority among the multiple, concurrent PUSCH transmissions. In an example, a UE first scales down the Tx power of the PUSCH transmission with the highest MCS for scenarios where UE is power limited and needs to scale down the PUSCH Tx power so as to not exceed the maximum allowed Tx power. In an example, the PUSCH transmission carrying medium access control-control elements (MAC CEs) has the highest relative priority among the multiple PUSCH transmissions for a power limited scenario (e.g., Tx power of a PUSCH carrying MAC CEs should be scaled down last since it contains important control information).

In one or more implementations, a PHR value is reported for scenarios where a UE has multiple overlapping UL grants in a slot for a serving cell for which a PHR is being reported. According to an implementation, the PUSCH power being used for the calculation of the PHR is determined as the sum of the UL Tx power for each of the PUSCH transmissions. According to an alternative implementation, the UE calculates and/or reports the PHR for one single UL grant in a serving cell, for scenarios where the UE has multiple overlapping UL grants for the serving cell. In one example, a predefined UL grant is used for the calculation of the PHR (e.g., the UL grant with the lowest MCS or first PUSCH allocation signaled within the DCI). According to an alternative implementation, multiple PHR values are reported for a serving cell, one for each PUSCH allocation or UL grant, for cases where a UE has been allocated with multiple overlapping UL grants in one serving cell. In an implementation, a UE transmits a PHR MAC CE on the PUSCH with the lowest MCS for cases where the UE is allocated with multiple (overlapping) UL grants in one slot for one serving cell.

In one or more implementations, a UE multiplexes and transmits MAC CE(s) on the UL grant having the lowest MCS for scenarios where the UE has multiple UL grants corresponding to multiple of (at least) overlapping PUSCH transmissions. To ensure that MAC CE(s) carrying important control information is best protected, the UE multiplexes MAC CE(s) in a TB using the lowest MCS among the available TBs. According to one example, the UE muxes MAC CE(s) to the first UL grant, resources, and/or TB assigned by a DCI allocating multiple UL grants, allocations, and/or TBs.

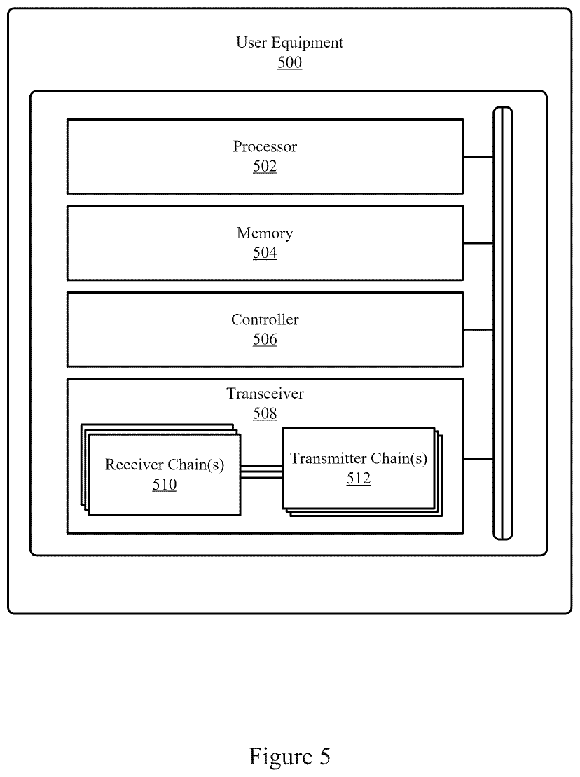

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to or operable to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving multiple uplink resource assignments for overlapping scheduled uplink transmissions; and performing LCP procedures, where an LCP procedure of the LCP procedures is performed for each of the multiple uplink resource assignments.

Additionally, the UE 500 may be configured to or operable to support any one or combination of the method further including performing the LCP procedures in a predefined order. The method further including receiving DCI that includes the multiple uplink resource assignments, and where the DCI includes indications of at least one MCS for each of the scheduled uplink transmissions. The LCP procedure is a single LCP procedure performed for the multiple uplink resource assignments that schedule the overlapping scheduled uplink transmissions. The overlapping scheduled uplink transmissions are at least partially overlapping in time domain. The method further including performing the LCP procedures in an order of a MCS that is associated with an uplink resource assignment of the multiple uplink resource assignments. A first LCP of the LCP procedures is performed for the uplink resource assignment associated with a lowest MCS of multiple MCSs associated with the multiple uplink resource assignments.

Additionally, or alternatively, the UE 500 may support at least one memory (e.g., the memory 504) and at least one processor (e.g., the processor 502) coupled with the at least one memory and configured to or operable to cause the UE to receive multiple uplink resource assignments for overlapping scheduled uplink transmissions; and perform LCP procedures, where an LCP procedure of the LCP procedures is performed for each of the multiple uplink resource assignments.

Additionally, the UE 500 may be configured to or operable to support any one or combination of the at least one processor is operable to cause the UE to perform the LCP procedures in a predefined order. The at least one processor is operable to cause the UE to receive DCI that includes the multiple uplink resource assignments, and where the DCI includes indications of at least one MCS for each of the scheduled uplink transmissions. The LCP procedure is a single LCP procedure performed for the multiple uplink resource assignments that schedule the overlapping scheduled uplink transmissions. The overlapping scheduled uplink transmissions are at least partially overlapping in time domain. The at least one processor is operable to cause the UE to perform the LCP procedures in an order of a MCS that is associated with an uplink resource assignment of the multiple uplink resource assignments. A first LCP of the LCP procedures is performed for the uplink resource assignment associated with a lowest MCS of multiple MCSs associated with the multiple uplink resource assignments.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

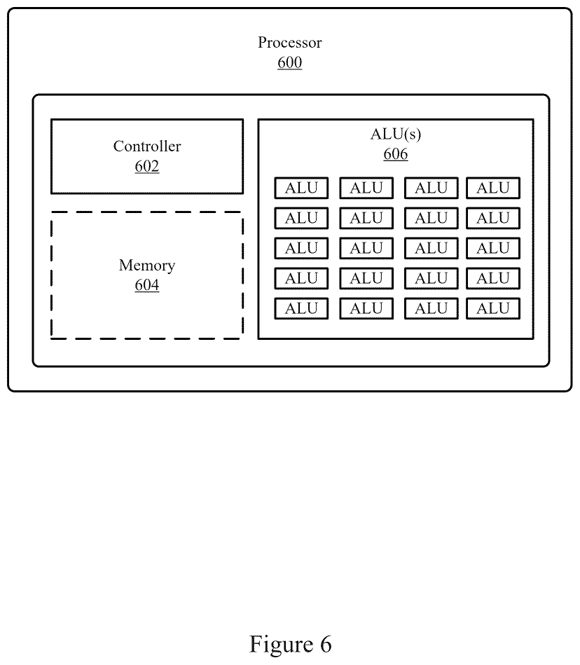

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to support at least one controller (e.g., the controller 602) coupled with at least one memory (e.g., the memory 604) and configured to or operable to cause the processor to receive multiple uplink resource assignments for overlapping scheduled uplink transmissions; and perform LCP procedures, where an LCP procedure of the LCP procedures is performed for each of the multiple uplink resource assignments.

Additionally, the processor 600 may be configured to or operable to support any one or combination of the at least one controller is operable to cause the processor to perform the LCP procedures in a predefined order. The at least one controller is operable to cause the processor to receive DCI that includes the multiple uplink resource assignments, and where the DCI includes indications of at least one MCS for each of the scheduled uplink transmissions. The LCP procedure is a single LCP procedure performed for the multiple uplink resource assignments that schedule the overlapping scheduled uplink transmissions. The overlapping scheduled uplink transmissions are at least partially overlapping in time domain. The at least one controller is operable to cause the processor to perform the LCP procedures in an order of a MCS that is associated with an uplink resource assignment of the multiple uplink resource assignments. A first LCP of the LCP procedures is performed for the uplink resource assignment associated with a lowest MCS of multiple MCSs associated with the multiple uplink resource assignments.

The processor 600 may support wireless communication in accordance with examples as disclosed herein. The processor 600 may be configured to support at least one controller (e.g., the controller 602) coupled with at least one memory (e.g., the memory 604) and configured to or operable to cause the processor to transmit DCI that includes multiple uplink resource assignments for overlapping scheduled uplink transmissions, where the DCI includes indications of at least one MCS for each of the scheduled uplink transmissions.

Additionally, the processor 600 may be configured to or operable to support any one or combination of the overlapping scheduled uplink transmissions are at least partially overlapping in time domain. An LCP procedure is associated with each of the multiple uplink resource assignments.

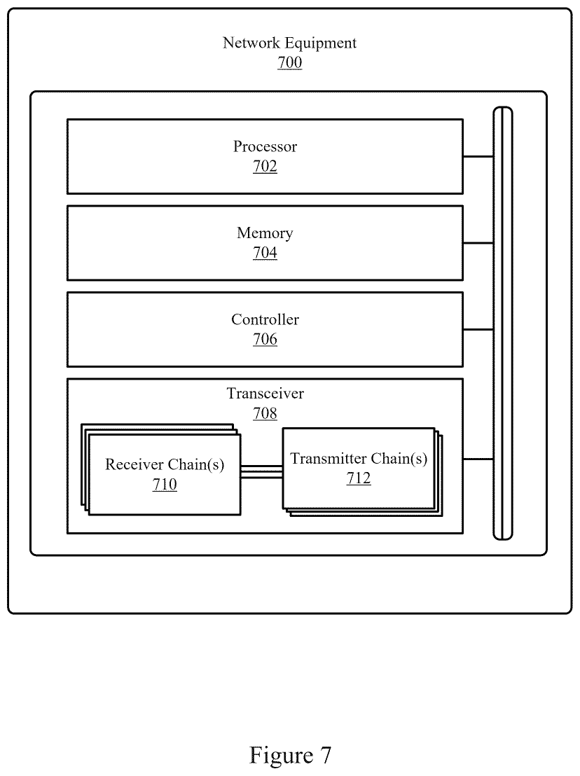

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting DCI that includes multiple uplink resource assignments for overlapping scheduled uplink transmissions, where the DCI includes indications of at least one MCS for each of the scheduled uplink transmissions.

Additionally, the NE 700 may be configured to or operable to support any one or combination of the overlapping scheduled uplink transmissions are at least partially overlapping in time domain. An LCP procedure is associated with each of the multiple uplink resource assignments.

Additionally, or alternatively, the NE 700 may support at least one memory (e.g., the memory 704) and at least one processor (e.g., the processor 702) coupled with the at least one memory and configured to or operable to cause the NE to transmit DCI that includes multiple uplink resource assignments for overlapping scheduled uplink transmissions, where the DCI includes indications of at least one MCS for each of the scheduled uplink transmissions.

Additionally, the NE 700 may be configured to or operable to support any one or combination of the overlapping scheduled uplink transmissions are at least partially overlapping in time domain. An LCP procedure is associated with each of the multiple uplink resource assignments.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

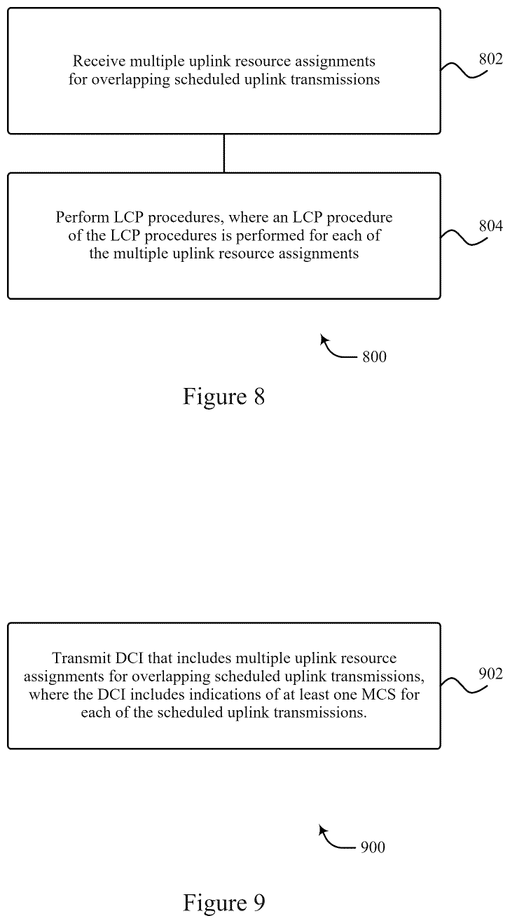

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving multiple uplink resource assignments for overlapping scheduled uplink transmissions. The operations of 802 may be performed in accordance with examples as described herein. In some implementations, aspects of the operations of 802 may be performed by a UE as described with reference to FIG. 5.

At 804, the method may include performing LCP procedures, where an LCP procedure of the LCP procedures is performed for each of the multiple uplink resource assignments. The operations of 804 may be performed in accordance with examples as described herein. In some implementations, aspects of the operations of 804 may be performed by a UE as described with reference to FIG. 5.

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting DCI that includes multiple uplink resource assignments for overlapping scheduled uplink transmissions, where the DCI includes indications of at least one MCS for each of the scheduled uplink transmissions. The operations of 902 may be performed in accordance with examples as described herein. In some implementations, aspects of the operations of 902 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive multiple uplink resource assignments for overlapping scheduled uplink transmissions; and
perform logical channel prioritization (LCP) procedures, wherein an LCP procedure of the LCP procedures is performed for each of the multiple uplink resource assignments.

2. The UE of claim 1, wherein the at least one processor is operable to cause the UE to perform the LCP procedures in a predefined order.

3. The UE of claim 1, wherein the at least one processor is operable to cause the UE to receive downlink control information (DCI) that includes the multiple uplink resource assignments, and wherein the DCI includes indications of at least one modulation and coding scheme (MCS) for each of the scheduled uplink transmissions.

4. The UE of claim 1, wherein the LCP procedure is a single LCP procedure performed for the multiple uplink resource assignments that schedule the overlapping scheduled uplink transmissions.

5. The UE of claim 1, wherein the overlapping scheduled uplink transmissions are at least partially overlapping in time domain.

6. The UE of claim 1, wherein the at least one processor is operable to cause the UE to perform the LCP procedures in an order of a modulation and coding scheme (MCS) that is associated with an uplink resource assignment of the multiple uplink resource assignments.

7. The UE of claim 6 wherein a first LCP of the LCP procedures is performed for the uplink resource assignment associated with a lowest MCS of multiple MCSs associated with the multiple uplink resource assignments.

8. A method performed by a user equipment (UE), the method comprising:
receiving multiple uplink resource assignments for overlapping scheduled uplink transmissions; and
performing logical channel prioritization (LCP) procedures, wherein an LCP procedure of the LCP procedures is performed for each of the multiple uplink resource assignments.

9. The method of claim 8, further comprising:
performing the LCP procedures in a predefined order.

10. The method of claim 8, further comprising:
receiving downlink control information (DCI) that includes the multiple uplink resource assignments, and wherein the DCI includes indications of at least one modulation and coding scheme (MCS) for each of the scheduled uplink transmissions.

11. The method of claim 8, wherein the LCP procedure is a single LCP procedure performed for the multiple uplink resource assignments that schedule the overlapping scheduled uplink transmissions.

12. The UE of claim 8, wherein the overlapping scheduled uplink transmissions are at least partially overlapping in time domain.

13. The method of claim 8, further comprising:
performing the LCP procedures in an order of a modulation and coding scheme (MCS) that is associated with an uplink resource assignment of the multiple uplink resource assignments.

14. The method of claim 13, wherein a first LCP of the LCP procedures is performed for the uplink resource assignment associated with a lowest MCS of multiple MCSs associated with the multiple uplink resource assignments.

15. A network equipment (NE) for wireless communication, comprising:
at least one memory; and
at least one processor coupled with the at least one memory and operable to cause the NE to:
transmit downlink control information (DCI) that includes multiple uplink resource assignments for overlapping scheduled uplink transmissions, wherein the DCI includes indications of at least one modulation and coding scheme (MCS) for each of the scheduled uplink transmissions.

16. The NE of claim 15, wherein the overlapping scheduled uplink transmissions are at least partially overlapping in time domain.

17. The NE of claim 15, wherein a logical channel prioritization (LCP) procedure is associated with each of the multiple uplink resource assignments.

18. A method performed by a network equipment (NE), the method comprising:
transmitting downlink control information (DCI) that includes multiple uplink resource assignments for overlapping scheduled uplink transmissions, wherein the DCI includes indications of at least one modulation and coding scheme (MCS) for each of the scheduled uplink transmissions.

19. The method of claim 18, wherein the overlapping scheduled uplink transmissions are at least partially overlapping in time domain.

20. The method of claim 18, wherein a logical channel prioritization (LCP) procedure is associated with each of the multiple uplink resource assignments.
